(19) United States
(12) Patent Application Publication
(10) Pub. No.: US 2023/0400202 A1
(43) Pub. Date: Dec. 14, 2023

(54) ATTIC VENTILATION SYSTEM

(71) Applicant: Roof Turbo, LLC, Manchester, MI (US)

(72) Inventor: Kurt Greaves, Manchester, MI (US)

(21) Appl. No.: 18/141,699

(22) Filed: May 1, 2023

Related U.S. Application Data
(60) Provisional application No. 63/350,096, filed on Jun. 8, 2022.

(51) Int. Cl. F24F 7/02; H02S 20/23

(52) U.S. Cl. CPC F24F 7/025; H02S 20/23; F24F 13/0254

(57) ABSTRACT

An attic ventilation system is provided including a tube having a proximal end mounted to a soffit opening and a distal end to which a fan is mounted inside an attic space, the fan operable to pull airflow into the tube through the proximal end and discharge the airflow at a rate of at least 10 CFM into the attic space to provide ventilation thereto. The fan can be configured to be mounted to the rafter in a suspended or supported orientation inside the attic space, distal from the soffit. The system can include a solar panel mountable to a roof structure disposed above the attic space and above the soffit, and a power cord configured to electrically couple the solar panel to the fan to power the fan.

### BACKGROUND OF THE INVENTION

The present invention relates to ventilation systems, and more particularly to an attic ventilation system that pulls in ambient air through soffits.

Many buildings include ventilation systems to reduce the negative effect of heat and humidity, particularly in attic spaces located above work and living areas in the buildings. Solar energy impinging the roof of a building heats air in an attic during the day. At night, however, the roof typically cools, and thus cools and condenses air in the attic located below the roof. As a result, the air in the attic can become more humid. In turn, the moisture in the air can settle out on insulation and wood structures in the attic. Over time, the repeated deposition of moisture on the insulation and wood structures in the attic can cause them to deteriorate and/or decay. The moist environment can also attract insects and can result in mold growing in the attic on structures.

The solar energy impinging the roof also can excessively heat up the air in the attic space. Throughout the day, excess heat in the attic can transfer to the adjacent work and living areas under the attic. As the air temperature in the attic rises due to solar energy, the temperature in the work and living areas usually rises, and sometimes substantially. This can require additional room ventilation or air conditioning in those areas to provide suitable living, work or storage temperatures. In turn, this can consume excess energy to cool the living, work or other areas under the attic.

Some construction entities have attempted to address excess heat and humidity in attic spaces. A common approach is to install passive soffit mounted vents that allow ambient air to passively enter and exit the attic space. While these passive ventilation soffits work on windy days, they do not work so well when the air around the building is stagnant, hot and/or humid.

Another attempt to provide attic ventilation utilizes soffit mounted fans, such as that shown in U.S. Patent Application 2011/0217194 to Randall. This fan, which is mounted directly to the soffit, however, can be prone to failure due to its exposure to the elements on the soffit. The fan can draw in moisture, dust and debris that directly encounters the fan, and can cause it to malfunction or prematurely wear out. Further, the position of the fan in or under the soffit can cause excess vibration in the soffit, and can yield an annoying tinny hum when the fan is in operation. Further, the mounting of the solar cell on the gutter is unsightly and can be prone to damage when cleaning the gutters.

Accordingly, there remains room for improvement in the field of active ventilation systems that are connected to soffits in a building or other structure.

### SUMMARY OF THE INVENTION

An attic ventilation system is provided including a tube having a proximal end mounted to a soffit opening and a distal end to which a fan is mounted inside an attic space. The fan can be distal from the soffit and the environment, in this location in the attic space. The fan can be operable to pull airflow into the tube through the proximal end and discharge the airflow at a rate of at least 10 CFM into the attic space to provide ventilation thereto, and/or to provide positive pressure inside the attic space.

In one embodiment, the system can include a solar panel mountable to a roof structure disposed above the attic space and above the soffit, and a power cord configured to electrically couple the solar panel to the fan to power the fan.

In another embodiment, the solar panel can be mounted to the roof structure at least ⅓ the way up the run from an overhang to a roof ridge of the roof structure. This can place the solar panel high enough up the roof to acquire adequate exposure to sunlight.

In still another embodiment, the attic space can be bounded by an insulation layer below multiple rafters that support the roof structure. The fan in this case can be disposed at least 2 feet above the insulation layer.

In still another embodiment, the soffit can define a soffit opening. The soffit can be positioned under an overhang of a roof. A trim ring can surround the soffit opening. In some cases, the trim ring can conceal an uneven cut edge of the soffit surrounding the soffit opening defined by the soffit.

In yet another embodiment, the overhang supporting the soffit can extend outward from a wall below the roof structure. The soffit opening can be located on a first side of the wall with the overhang. The fan, however, can be located on a second side of the wall, opposite the first side of the wall, in the attic space and above the wall.

In even another embodiment, the attic ventilation system can include a first band fastened to the rafter and supporting the tube in an upwardly angled orientation. The fan can be joined with the distal end of the tube and supported by a second band, also fastened to the rafter.

In a further embodiment, the attic space can be bounded by an insulation layer below the rafters. The fan can be disposed at least 2 feet above the insulation layer. Further, the roof structure can include a run distance extending from a roof ridge to the overhang, where the fan is located at least ⅓ the run distance from the overhang.

The attic ventilation system of the current embodiments herein can provide an efficient way to provide positive pressure inside an attic. This in turn can keep moisture and condensation from developing inside the attic space. The air flow produced by the fan can impair mold from forming in the attic space, and can keep dirt, debris and other foreign items from entering the attic space. The system can be used to evacuate the attic space of warm or hot air, thereby improving cooling in living and work spaces within a building. With the solar powered fan included, the system can be economical to operate, and can consume no net energy from the building or grid. Further, the system can locate the fan inside the attic space so that it is not subject to the elements, such as rain, snow and moisture in the air under the soffit. Where the fan is located distal from the soffit opening and soffit in general, any moisture, debris and other objects can settle out in the tube before reaching the fan, which can reduce wear and tear on the fan itself.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of an attic ventilation system of the current embodiment installed in a building with some portions broken away or in cross section.

FIG. 2 is a perspective view of a fan of the system installed in a rafter system.

FIG. 3 is an exploded perspective view of a soffit opening of the system, and a trim ring being installed to conceal a rough opening in the soffit.

FIG. 4 is a schematic of various components of the attic ventilation system before installation in a building.

### DETAILED DESCRIPTION OF THE CURRENT EMBODIMENTS

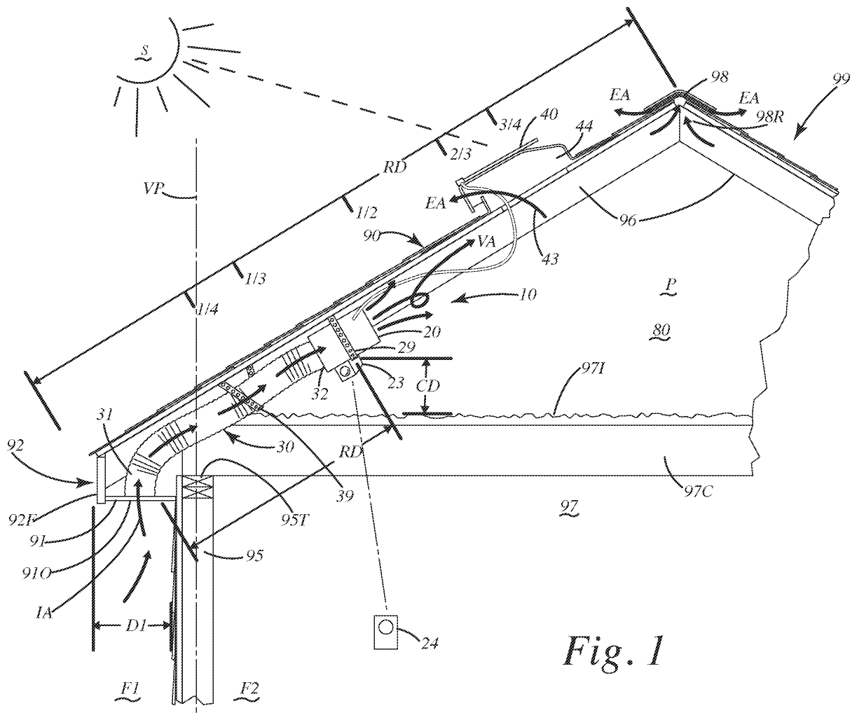

An attic ventilation system of a current embodiment is shown in FIGS. 1-4 and generally designated 10. The attic ventilation system 10 generally can include a fan 20 mounted in an attic space 80 and joined with a tube 30 that extends to one or more soffits 91 disposed in an overhang 92 of a roof structure 90. The fan 20 can be completely mounted within the attic space 80 and distal from the soffit 91, which can define a soffit opening 910 through which ambient intake air IA can be pulled or drawn by the fan 20, through the tube 30 and eventually output into the attic space 80 as ventilating air VA. The fan 20 can increase the pressure P within the attic space 80 so that it is greater than an ambient pressure outside the attic 80, for example outside the building structure 99 and in the environment. This in turn can create a positive pressure P inside the attic 80. The fan 20 can produce the positive pressure to a level such that air exhausts as exhaust air EA through a primary vent 98, shown as a ridge vent, optionally at the peak or ridge 98R of the roof structure 90 of the building 99. The fan 20 can be powered by a solar cell or panel 40 that is mounted exterior to the attic 80 on the roof structure 90, and optionally facing in a generally southern direction toward the sun S to be satisfactorily suitably operated or charged by solar energy impinging the panel. The solar panel 40 can be electrically coupled via a power cable 43 to the fan 20. Optionally, the solar panel 40 can be mounted to a secondary roof vent 44 in some applications. In that case, where the building 99 includes a secondary vent 44 in addition to ridge vent or other roof vent 98, the fan creating the positive pressure P inside the attic space 80 can assist in expelling exhaust air EA through the secondary roof vent 44 as well. It will be noted that when the exhaust air EA is expelled from the primary vent 98, the secondary vent 44 or any other roof vent or venting apparatus associated with the roof structure, any heated or higher temperature air within the attic space 80 can be exhausted from the attic space 80, generally out into the environment. In turn, this can facilitate cooling of the attic 80, and the building 99 in general. This further can reduce the temperature of the living, work and/or storage space 97 located below the attic space 80 within the building 99. This can reduce any associated cooling costs for such space 97.

With reference to FIGS. 1-3, the attic ventilation system 10 can be installed in the building 99. The building 99 can be a home, garage, storage facility, commercial building, retail outlet or any other type of building. The building can be configured to include a roof structure 90 over an attic 80. The roof structure can include multiple rafters 96. The rafters 96 can be in the form of conventional rafters or can be formed as a part of a truss or other roof structure. The rafters 96 can be spaced from one another about 24 inches or according to local building codes. The roof structure 90, including the rafters 96 can include sheeting and shingles or other roofing components, such as tiles, sheet metal or the like. The roof structure 90 as mentioned above can include a primary vent 98 such as a ridge vent mounted at a peak or ridge 98R of the roof structure 90. This roof vent can provide an opening for exhaust air EA to be expelled from the attic space when adequately pressurized with a positive pressure P relative to the external pressure in the environment surrounding the building. Optionally, as shown, the roof structure 90 also can include a secondary vent, which can be a standard roof vent, which also optionally can provide an output for exhaust air EA to escape the attic 20 when positively pressured by the fan 20.

The building 99 can include the noted attic space 80 and another work, living and/or storage space 97 below a ceiling 97C. The ceiling 97C, or generally the lower portion of the attic can include an insulation layer 971 which can provide thermal insulation between the attic 80 and the space 97 below it. This insulation layer can be any type of conventional insulation such as batting, spray in foam, foam sheets or the like. Although not shown, additional baffles or venting can be provided between individual ones of the multiple rafters 96 above the attic space 90.

With reference to FIG. 1, the building 99 can be configured such that the roof structure 90 extends outwardly a distance D1 from an outer wall 95 that can support a portion of the ceiling 97, the rafters 96 and/or the roof structure 90. Where the roof structure extends outwardly the distance D1, which optionally can be 1 foot, 2 feet, 3 feet or other dimensions depending on the building 99, it forms the overhang 92. This overhang 92 can be capped by fascia 92F on its outer most portion. The fascia 92F can be disposed the distance D1 from the wall 95. The wall 95 can extend along a vertical plane VP. As shown in FIG. 1, the vertical plane can include a first side F1 and a second side F2. The soffit 91, overhang 92 and soffit opening 910 can be disposed in the first side F1. Likewise, the proximal end 31 of the tube 30 can be disposed with its opening adjacent the soffit opening 910 on the first side F1 of the wall 95. As explained further below, the remainder of the tube 30, the distal or second end 32 of the tube, along with the fan 20, can be disposed on the second side F2 of the vertical plane VP, as shown located within the attic space 80 and adjacent one or more of the rafters 96.

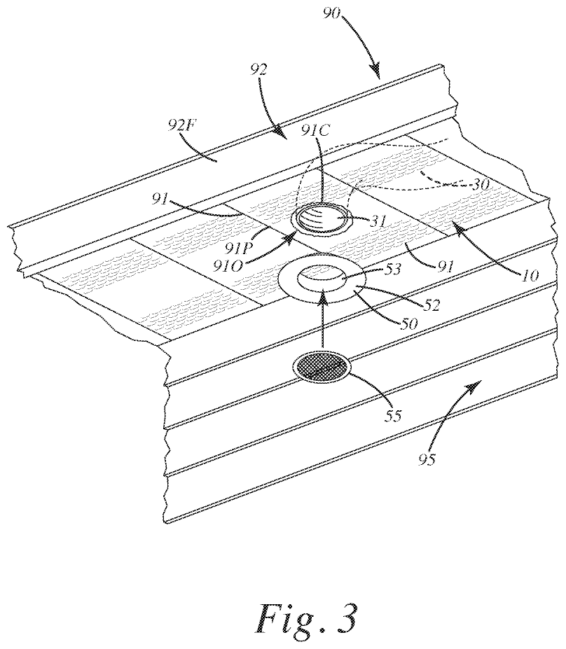

As shown in FIG. 3, the overhang 92 with the fascia 92F and the soffit 91 can extend outwardly from the wall 95. The soffit 91 can include a panel 91P defining a soffit opening 910. Multiple ones of these panels 91P can be joined with one another and can extend along the length of the overhang. The soffit opening 910 can be cut within the panel 91P of the soffit 91. The soffit panel 91P also can be modified manually on a job site to include the opening 910. When this is done, the soffit panel 91P can be cut with a tool, such as tin snips, to form a cut edge 91C that bounds a perimeter of the soffit opening 910. Typically, this cut edge can be an uneven cut edge which may not be aesthetically appealing. Accordingly, the attic ventilation system 10 can include a trim ring 50 which can include a flange 52 that extends outwardly away from the opening 91 and conceals the uneven cut edge 91C, or any other type of edge forming the opening in the soffit. The trim ring 50 optionally can include a collar 53 that extends upwardly into the opening 910, or extends slightly below it, which can be fastened to the soffit panel 91P to secure the trim ring 50 in place. The trim ring 50 optionally can be joined with an optional screen 55 before or after the trim ring is installed. The screen can cover the opening 910 with the trim ring such that debris does not easily enter the tube 30. In addition, this can keep animals from entering the opening in the tube. In some applications, however, the trim ring and/or the screen 55 can be absent from the construction.

Returning to FIG. 1, the attic ventilation system 10 as mentioned above can include a tube 30 that extends from the soffit opening 910 to the fan 20. The tube 30 can include a proximal end 31 which disposed adjacent and in fluid communication with the soffit opening 900 and a distal end 32 which is in fluid communication with and optionally joined with the fan 20. The tube 30 can include a central portion 33 that extends between the proximal end 31 and a distal end 32. This central portion 33 can extend in an upwardly angled disposition relative to the ceiling 97C. The central portion also can transition from one side F1 of the vertical plane VP of the wall 95 to the second side F2 as it extends generally upwardly. The tube 30 also can extend between one or more rafters, at least in some portions of the central portion and/or the distal end. The proximal end 31 as shown optionally can be disposed on the first side F1 of the wall 95 and below the ceiling 97C in some cases. The central portion 33 and/or the overall length of the tube 30 optionally can be at least 3 feet, at least 4 feet, at least 5 feet, at least 7 feet, at least 8 feet, at least 9 feet, or at least 10 feet long.

In some applications, the overall distance PD of the fan 20 from the soffit opening 910 can be the same or a similar length as the central portion or overall length of the tube. Optionally, the overall distance PD can be selected so that the fan 20 can adequately draw enough volume of intake air IA without expending significant energy or power to run the fan 20. This can allow the fan to be a relatively low voltage, low output fan, which can suitably be powered by the solar panel 40 or any secondary batteries 20B that may be associated with the fan 20. Further optionally, the overall distance PD can be less than 12 feet, less than 11 feet, less than 10 feet, less than 9 feet, less than 8 feet, less than 7 feet, less than 6 feet, less than 5 feet, or less than 4 feet depending on the application and the attic space. Again, with the shorter overall distance PD, the fan 20, which can be low output fan, can suitably pull air from the opening 910 at the proximal end 31 of the tube without requiring too much electricity or power from the solar panel and/or secondary batteries 20B.

The fan 20, as well as solar panel 40 also can be located on the roof structure 90 generally between the roof overhang 92 in the roof ridge 98R. The placement of these elements can be sufficiently distal from the overhang 92 in the soffit 91 so that the fan is adequately disposed in the attic 80 to pump ventilating air VA into that space and produce a positive pressure P within the space. The solar panel 40 also can be located along the roof structure such that the panel is distal from the overhang and sufficiently high on the roof to collect enough solar energy from the sun S. Optionally, both the fan 20 and solar panel 40 can be disposed on the second side F2 of the vertical plane VP of the wall 95 opposite the overhang 92 and/or soffits 91 on the first side F1.

The fan 20 and/or solar panel 40 can be positioned at certain locations along the run distance RD of the roof structure 90 that extends from the overhang 92 to the roof ridge 98R. For example, the solar panel 40 can be located at least ¼, at least ⅓, at least ½, at least ¾ or at least ⅔ the run distance RD from the overhang. The fan 20 can be located at least ¼, at least ⅓, at least ½, at least ¼, at least ⅓, at least ½, at least ¾, at least ⅔ the run distance RD from the overhang. In other applications, the fan 20 can be located from ¼ to ⅓ the run distance, ⅓ to ⅔ the run distance, ½ to ¾ the run distance, or ⅓ to ⅔ the run distance, from the overhang, depending on the application.

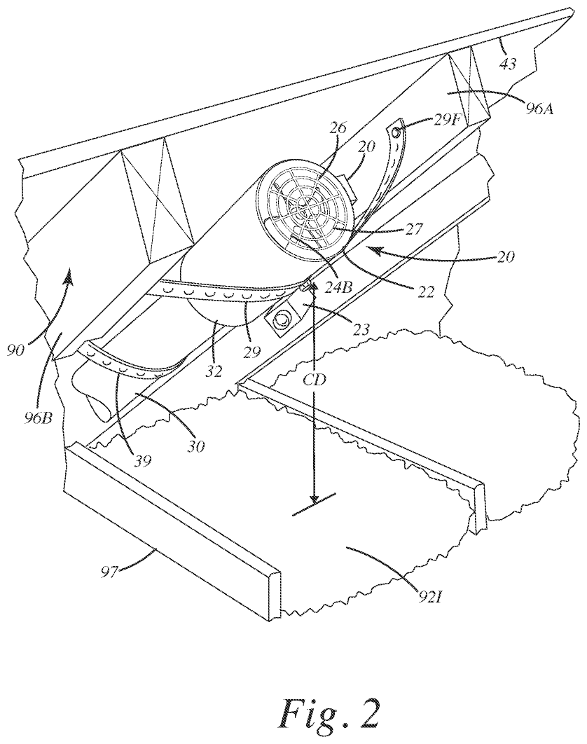

The tube 30, extending from the proximal end 31 to the distal end 32, can be a rigid or flexible tube. In some cases, the tube can be flexible, which can include semi rigid or semi flexible tubes. In this construction, the tube can be easily manipulated, rerouted and directed from the soffit opening 910, over the top 95T of the wall 95, and adjacent and/or between certain ones of the rafters 96. In some cases, although shown between rafters 96A and 96B in FIG. 2, the tube 30 and optionally the fan 20 can be secured directly under one of those rafters 96A or 96B. In other applications, the tube and fan can be supported by a stand or bracket that extends upward from the ceiling 97C in the attic space. In either case, the fan 20 and tube can be considered to be suspended.

With further reference to FIG. 2, the fan 20 can be located at the distal end 32 of the tube. The fan 20 can be attached to the tube via a clamp, zip tie, fasteners or other types of connecting elements. The fan 20 as well as the tube 30 optionally can be fastened or otherwise secured to the rafters 96 or some portion of the roof structure 90 and/or the ceiling 97C via one or more bands 29 and 39. The bands as shown can be elongated elements optionally including one or more holes defined therein. Fasteners 29F can be placed through one or more holes defined by the bands 29 to fasten the ends or other portions of the bands to the rafters, roof structure, ceiling or otherwise in the attic space. The bands as used herein can take on a variety of shapes, configurations and constructions, optionally constructed from metal, plastic, composites or the like. The bands 29 and 39 can be in the form of rigid or flexible elongated elements that can be secured to the rafters, roof structure, ceiling, or other components inside the attic space. In some cases, the bands can be in the form of strips, cords, wire, rope, or other elongated pieces. In other cases, the bands can be in the form of rigid or semi rigid brackets that can be secured to the rafters, the ceiling or elsewhere in the attic space. These bands can be part of the fan 20 or can be separate pieces from the fan. Further, although shown as suspending the fan 20 and/or tube 30 from the rafters or roof structure, the bands can support the elements by extending upward from the ceiling 97C or some other structure of the building 99. Furthermore, where the fan or tube are referred to as suspended, this can refer to supporting the fan and/or tube from below those elements, as well as from above those elements.

When mounted to the rafters 96 or some other structure within the attic space 80, the fan 20 can be disposed below the roof structure 90 and above the ceiling 97C, as well as any optional insulation 971. As shown in FIG. 1, the fan 20 can be mounted so that the exhaust end 22 of the fan is disposed a clearance distant CD from the insulation 971. This is so that the fan does not inadvertently blow or disrupt the insulation and circulate fibers or other material from the insulation within attic 80. The distance CD can optionally be at least 2 feet, at least 3 feet, at least 4 feet, at least 5 feet or at least 10 feet above the insulation layer, depending on the application.

With further reference to FIG. 2, the fan optionally can be a low voltage direct current coaxial fan. Fan 20 can include one or more blades 24B that can be suitably covered by a shroud 26 for safety reasons. The fan can include a blush brushless motor 27 that can be operable at optionally less than 20 V, less than 12 V, or less than six volts DC depending on the application. The fan can be operable such that it can output air from the exhaust side 22 at an airflow rate of at least 5 CFM, at least 10 CFM, at least 15 CFM, at least 20 CFM or other comparable generally low flow rates. The fan 20 can output airflow at certain speeds, for example at least 5 miles per hour, at least 10 miles per hour, at least 15 miles per hour, at least 20 mph or other speeds depending on the application and other factors.

Although shown as a single fan installed in the attic 80, there can be multiple fans and associated tubes mounted in the attic 80. These multiple fans and tubes can extend from corresponding respective soffits 91 and respective openings 910 along the overhang 92 of the roof structure 90. The number of fans can be selected depending on the suitable airflow, cooling and temperature in the attic 80, as well as other parameters.

As shown in FIGS. 1 and 2, the fan 20 optionally can include a thermostat and/or humidistat 23 on the housing of the fan. This can control the operation of the fan according to a preset temperature or humidity. The preset temperature and/or humidity can be set manually by user using a control knob or other input on the thermostat and/or humidistat 23. The fan 20 can start, run and stop depending on control signals provided by the thermostat and/or humidistat 23. Further optionally, the fan 20 can be remotely controlled by a secondary thermostat and/or humidistat 24. This secondary thermoset and/or humidistat 24 can be placed in the living, work and/or storage space 97 below the ceiling 97C. This secondary thermostat and/or humidistat 24 also can include an input, such as a control knob, button or the like so that a user within the space 97 can set a temperature or humidity within the attic 80 at which the fan will be triggered to operate. The secondary thermostat and/or humidistat 24 can send wireless signals to the fan or a controller thereof to control the fan operation. In other cases, the secondary thermostat and/or humidistat can be hardwired to the fan to control its operation.

As mentioned above, the fan 20 can be powered by a solar panel 40. The solar panel 40 can be connected to the fan by a power cord 43. The solar panel 40 can be mounted somewhere on the roof structure 90, optionally above the fan 20 and tube 30. The fan can be mounted to a roof vent 44 as shown, or can be mounted via a support bracket that extends to the solar panel which can be adjustable to orient the solar panel 40 at different angles relative to the roof structure 90. The solar panel 40 can be oriented on the roof to maximize the amount of solar energy from the sun S impinging on the panel throughout the day and year.

As mentioned above, the ventilation system 10 can include optional secondary batteries 20B. These batteries can be charged by the solar panel 40 when the solar panel absorbs solar energy. The batteries thus can be used to power the fan 20 when the solar panel 40 is not absorbing solar energy during low sunlight days.

The attic ventilation system 10 can operate to produce a positive pressure P in the attic 80 using the fan 20 pulling intake air IA from the environment through the soffits 91 associated with the roof structure 90. The fan specifically can produce a negative pressure within the tube 30 which then draws an intake air IA through the opening 910 into the proximal end 31 of the tube. The air can continue to flow through the central portion 33 and distal end of the tube 32 until being blown by the fan 20 into the attic 80 as ventilation air VA. The ventilation air can pressurize the attic 80 with the pressure P. Where positive, the pressure can result in air being expelled through any respective vents 98 and 44 as exhaust air EA from the attic space 80 and generally from the building 90. Optionally, the fan can pull cool ambient intake air from the region under the overhang 92 and expel that as ventilation air VA into the attic space 80, which can be of a higher temperature air. As result, the overall air temperature in the attic 80 can decrease. This can result in a corresponding lower temperature in the living, work or storage space 97 within the building 99. Although shown as pulling in air through the intake, the fan also can be reversed to draw air out of the attic 80 and blow it through the soffit opening 910 into the environment, in some limited applications.

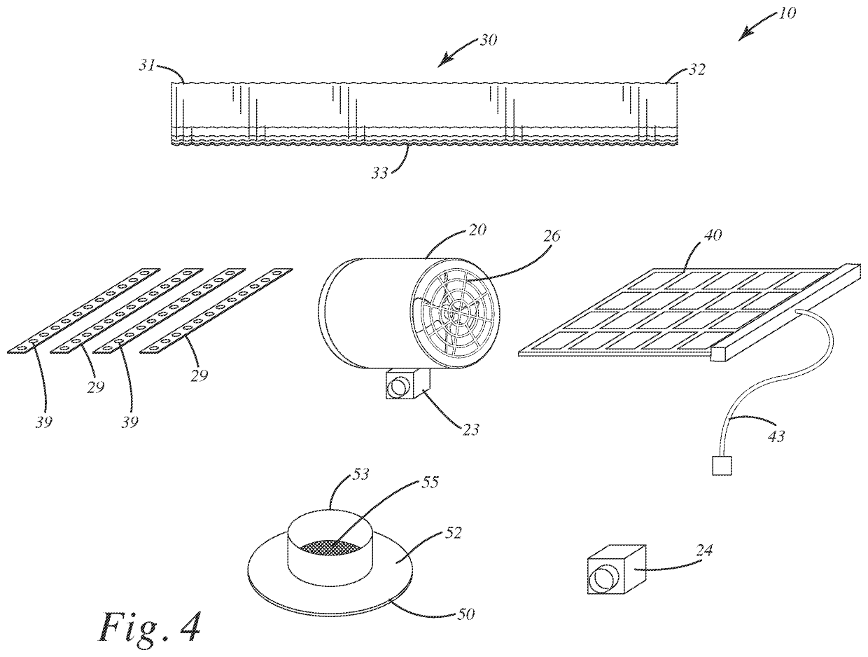

In some cases, the attic ventilation system 10 can be supplied in a kit form as shown in FIG. 4. There, the kit can include the tube 30, one or more bands 29, 39, the fan 20, the solar panel 40 as well as the trim ring 50 and an optional secondary thermostat and/or humidistat 24. Of course, other fasteners, connectors, controllers, cords and the like can be included in the kit depending on the application.

It will be appreciated that by identifying or naming herein certain elements as first, second, third, etc., that does not require that there always be a certain number of elements preceding, succeeding, above, below, adjacent and/or near the numbered elements. Further, any one of a numbered group of elements, for example, a third element, alternatively can be referred to as a first, second, fourth or other numbered row element. The same is true for the naming of any other elements in the form of a first element, second element, third element, etc. as used herein.

Although the different elements and assemblies of the embodiments are described herein as having certain functional characteristics, each element and/or its relation to other elements can be depicted or oriented in a variety of different aesthetic configurations, which support the ornamental and aesthetic aspects of the same. Simply because an apparatus, element or assembly of one or more of the elements is described herein as having a function does not mean its orientation, layout or configuration is not purely aesthetic and ornamental in nature.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

What is claimed is:

1. An attic ventilation system comprising:
a plurality of rafters supporting a roof structure under which an attic space is defined;
an overhang extending outward from a wall below the roof structure;
a soffit defining a soffit opening, the soffit positioned under the overhang;
a trim ring surrounding the soffit opening;
a flexible tube including a proximal end, a central portion and a distal end, the proximal end joined with the soffit and in fluid communication with the soffit opening, the central portion extending upward adjacent a rafter of the plurality of rafters;
a first band fastened to the rafter and supporting the central portion in an upwardly angled orientation; and
a fan joined with the distal end of the tube and supported by a second band fastened to the rafter,
wherein the fan is configured to pull air into the tube through the proximal end and discharge the air at a rate of at least 10 CFM into the attic space.

2. The attic ventilation system of claim 1,
wherein the attic space is bounded by an insulation layer below the plurality of rafters,
wherein the fan is disposed at least 2 feet above the insulation layer.

3. The attic ventilation system of claim 2,
wherein the roof structure includes a run distance extending from a roof ridge to the overhang,
wherein the fan is located at least ⅓ the run distance from the overhang.

4. The attic ventilation system of claim 3 comprising:
a solar panel mounted to the roof structure;
a power cord coupling the solar panel to the fan;
wherein the solar panel is located at least ⅓ the run distance from the overhang.

5. The attic ventilation system of claim 1,
wherein the trim ring conceals an uneven cut edge of the soffit surrounding the soffit opening defined by the soffit.

6. The attic ventilation system of claim 5,
wherein a screen is disposed adjacent the soffit opening adjacent the trim ring.

7. The attic ventilation system of claim 6,
wherein the central portion is less than six feet long,
wherein the fan is mounted between adjacent rafters of the plurality of rafters in the attic space.

8. The attic ventilation system of claim 1,
wherein the soffit opening is located on a first side of the wall with the overhang;
wherein the fan is located on a second side of the wall, opposite the first side of the wall, in the attic space and above the wall.

9. The attic ventilation system of claim 8 comprising:
a solar panel mounted on the second side of the wall above the attic space and above the wall,
wherein the solar panel is electrically coupled to the fan.

10. An attic ventilation system comprising:
a flexible tube including a proximal end, a central portion and a distal end, the proximal end configured to be joined with a soffit and in fluid communication with a soffit opening defined by the soffit, the central portion configured to extend upward adjacent a rafter disposed over an attic space in a building, the central portion configured to be supported adjacent the rafter and extend in an upwardly angled orientation; and
a fan joined with the distal end of the flexible tube and configured to be mounted to the rafter in a suspended orientation inside the attic space, distal from the soffit, the fan operable to pull air into the flexible tube through the proximal end and discharge the air at a rate of at least 10 CFM into the attic space;
a solar panel mountable to a roof structure disposed above the attic space and above the soffit; and
a power cord configured to electrically couple the solar panel to the fan.

11. The attic ventilation system of claim 10 comprising:
a screen configured to be placed adjacent the soffit opening;
a trim ring configured to conceal an uneven cut edge of the soffit surrounding the soffit opening defined by the soffit.

12. The attic ventilation system of claim 11,
wherein the fan is joined with the tube at the distal end and includes a mounting portion configured to receive a band that is fastenable to the rafter to suspend the fan from the rafter.

13. The attic ventilation system of claim 12,
wherein the central portion of the tube extends away from the fan and toward the soffit,
wherein the central portion extends over a wall,
wherein the proximal end is located on a first side of the wall,
wherein the fan is located on a second side of the wall, opposite the first side of the wall, in the attic space and above the wall.

14. The attic ventilation system of claim 11 comprising:
a band that is fastenable to the rafter to suspend the fan from the rafter.

15. An attic ventilation system comprising:
a plurality of rafters supporting a roof structure under which an attic space is defined;
an overhang extending outward from a vertical wall having a first side and a second side disposed on opposite sides of a vertical plane;
a soffit defining a soffit opening, the soffit positioned on the first side of the wall;
a flexible tube including a proximal end and a distal end, the proximal end joined with the soffit and in fluid communication with the soffit opening, the flexible tube extending upward adjacent a rafter of the plurality of rafters; and
a fan joined with the distal end of the tube and positioned on the second side of the wall, distal from the soffit,
wherein the fan is configured to pull airflow into the tube through the proximal end and discharge the airflow into the attic space.

16. The attic ventilation system of claim 15,
wherein the attic space is bounded by an insulation layer below the plurality of rafters,
wherein the fan is disposed at least 2 feet above the insulation layer.

17. The attic ventilation system of claim 15,
wherein the roof structure includes a run distance extending from a roof ridge to the overhang,
wherein the fan is located at least ⅓ the run distance from the overhang.

18. The attic ventilation system of claim 15 comprising:
a solar panel mounted to the roof structure;
a power cord coupling the solar panel to the fan;
wherein the roof structure includes a run distance extending from a roof ridge to the overhang,
wherein the solar panel is located at least ⅓ the run distance from the overhang.

19. The attic ventilation system of claim 15, comprising:
a trim ring configured to conceal an uneven cut edge of the soffit surrounding the soffit opening defined by the soffit.

20. The attic ventilation system of claim 15,
wherein the fan is joined with the tube at the distal end and includes a mounting portion configured to receive a band that is fastenable to the rafter to suspend the fan from the rafter;
wherein a trim ring conceals an uneven cut edge of the soffit surrounding the soffit opening defined by the soffit;
wherein the attic space is bounded by an insulation layer below the plurality of rafters,
wherein the fan is disposed at least 2 feet above the insulation layer,
wherein the roof structure includes a run distance extending from a roof ridge to the overhang,
wherein the fan is located at least ⅓ the run distance from the overhang.
